(19) United States
(12) Patent Application Publication
(10) Pub. No.: US 2026/0363937 A1
(43) Pub. Date: Nov. 19, 2026

(54) METHOD FOR CHARGING BATTERY USING BACK-ELECTROMOTIVE FORCE GENERATED BY MOTOR AND ELECTRONIC DEVICE PERFORMING SAID METHOD

(71) Applicant: SAMSUNG ELECTRONICS CO., LTD., Suwon-si (KR)

(72) Inventors: Gigun NAM, Suwon-si (KR); Jui LEE, Suwon-si (KR); Donghee LEE, Suwon-si (KR)

(21) Appl. No.: 19/733,442

(22) Filed: Jul. 7, 2026

Related U.S. Application Data
(63) Continuation of application No. PCT/KR2024/017652, filed on Nov. 8, 2024.

(30) Foreign Application Priority Data
Jan. 30, 2024 (KR) 10-2024-0014084
May 7, 2024 (KR) 10-2024-0059649

(51) Int. Cl. A61H 3/00; A61H 1/02; H02J 7/14

(52) U.S. Cl. CPC A61H 3/00; A61H 1/0244; H02J 7/1415; A61H 2003/007; A61H 2201/1207; A61H 2201/5084

(57) ABSTRACT

A battery charging method may include operations of: determining whether a switch connection condition is satisfied, on the basis of the current voltage of a battery and a target voltage of target power appearing in a driving module of a wearable device; when the switch connection condition is satisfied, electrically connecting the driving module and a BEMF regulating circuit by using a switch of the BEMF regulating circuit; generating charging power on the basis of the target power through a regulator of the BEMF regulating circuit; and charging the battery on the basis of the charging power through a charging circuit.

### CROSS-REFERENCE TO RELATED APPLICATIONS

This application is a continuation application of International Application No. PCT/KR2024/017652, filed on Nov. 8, 2024, in the Korean Intellectual Property Receiving Office, and claiming priority to KR Application No. 10-2024-0014084 filed Jan. 30, 2024 and KR Application No. 10-2024-0059649 filed May 7, 2024, the disclosures of which are all hereby incorporated by reference herein in their entireties.

### TECHNICAL FIELD

Certain example embodiments may relate to a technology for processing back-electromotive force (BEMF) generated by a motor, and for example, to a technology for charging a battery using BEMF.

### BACKGROUND ART

A change into aging societies has contributed to a growing number of people who experience inconvenience and pain from reduced muscular strength or joint problems due to aging. Thus, there is a growing interest in walking assistance devices that enable elderly users or patients with reduced muscular strength or joint problems to walk with less effort and/or to exercise.

### SUMMARY

A wearable device, according to an example embodiment, may include a base body disposed on, directly or indirectly, an area of a lower back of a user when the wearable device is worn on a body of the user, a waist support frame and a leg support frame configured to support at least a part of the body of the user, a thigh-fastening portion configured to fix the leg support frame to a thigh of the user, an inertial measurement unit (IMU) disposed within the base body, a driving module configured to generate torque to be applied to a leg of the user, wherein the driving module is disposed between the waist support frame and the leg support frame and may include a motor and/or a motor driver circuit, a back-Electro Motive Force (BEMF) regulating circuit configured to generate charging power by regulating target power appearing in the driving module, a charging circuit including a battery, at least one processor comprising processing circuitry, and memory storing instructions, wherein the instructions, when executed by the at least one processor individually and/or collectively, cause the wearable device to at least determine whether a switch connection condition is satisfied, based on a target voltage of the target power appearing in the driving module and a current voltage of the battery, in response to the switch connection condition being satisfied, electrically connect the driving module to the BEMF regulating circuit using a switch of the BEMF regulating circuit, generate charging power based on the target power through a regulator of the BEMF regulating circuit, and charge the battery based on the charging power through the charging circuit.

A battery charging method, according to an embodiment, performed by a wearable device, the wearable device including a base body disposed on, directly or indirectly, an area of a lower back of a user when the wearable device is worn on a body of the user, a waist support frame and a leg support frame configured to support at least a part of the body of the user, a thigh-fastening portion configured to fix the leg support frame to a thigh of the user, an inertial measurement unit (IMU) (comprising a sensor) disposed at least partially within the base body, a driving module configured to generate torque to be applied to a leg of the user, wherein the driving module is disposed between the waist support frame and the leg support frame and may include a motor and/or a motor driver circuit, a back-Electro Motive Force (BEMF) regulating circuit configured to generate charging power by regulating target power appearing in the driving module, a charging circuit including a battery, at least one processor, and memory storing instructions, and the battery charging method including an operation of determining whether a switch connection condition is satisfied based on a target voltage of target power appearing in the driving module and a current voltage of the battery, in response to the switch connection condition being satisfied, an operation of electrically connecting the driving module to the BEMF regulating circuit using the switch of the BEMF regulating circuit, an operation of generating charging power based on the target power through a regulator of the BEMF regulating circuit, and an operation of charging the battery based on the charging power through the charging circuit.

An electronic device, according to an embodiment, may include a driving module including a motor and/or a motor driver, a back-Electro Motive Force (BEMF) regulating circuit configured to generate charging power by regulating target power appearing in the driving module, a charging circuit including a battery, at least one processor comprising processing circuitry, and memory storing instructions, wherein the instructions, when executed by the at least one processor individually and/or collectively, cause the electronic device to at least: determine whether a switch connection condition is satisfied, based on a target voltage of the target power appearing in the driving module and a current voltage of the battery, in response to the switch connection condition being satisfied, electrically connect the driving module to the BEMF regulating circuit using the switch of the BEMF regulating circuit configured to generate charging power by regulating the target power, generate charging power based on the target power through a regulator of the BEMF regulating circuit, and charge the battery based on the charging power through the charging circuit.

### BRIEF DESCRIPTION OF DRAWINGS

The above and other aspects, features, and advantages of certain embodiments of the present disclosure will be more apparent from the following detailed description, taken in conjunction with the accompanying drawings.

FIG. 1 is a diagram illustrating an overview of a wearable device worn on a body of a user, according to an example embodiment.

FIG. 2 is a diagram illustrating an exercise management system including a wearable device and an electronic device, according to an example embodiment.

FIG. 3 is a rear schematic view of a wearable device, according to an example embodiment.

FIG. 4 is a left side view of a wearable device, according to an example embodiment.

FIGS. 5A and 5B are diagrams illustrating a configuration of a control system of a wearable device, according to an example embodiment.

FIG. 5C is a diagram illustrating a configuration of a driving module, according to an example embodiment.

FIG. 5D is a diagram illustrating a configuration of a control module, a driving module, a clipper circuit, and a back-electromotive force (BEMF) regulating circuit, according to an example embodiment.

FIG. 6 is a diagram illustrating an interaction between a wearable device and an electronic device, according to an example embodiment.

FIG. 7 is a diagram illustrating a configuration of an electronic device, according to an example embodiment.

FIG. 8 is a flowchart of a method of charging a battery, according to an example embodiment.

FIG. 9 is a diagram illustrating a configuration of a BEMF regulating circuit, according to an example embodiment.

FIG. 10 is a flowchart of a method of outputting target power by clipping combined power appearing in a driving module, according to an example embodiment.

FIG. 11 is a diagram illustrating a configuration of a clipper circuit for clipping combined power appearing in a driving module, according to an example embodiment.

FIG. 12 is a flowchart of a method of determining whether a switch connection condition is satisfied, according to an example embodiment.

FIG. 13 is a flowchart of a method of supplying operating power to a motor based on charging power through a charging circuit, according to an example embodiment.

### DETAILED DESCRIPTION

Hereinafter, various embodiments of the present disclosure will be described with reference to the accompanying drawings. However, this is not intended to limit the present disclosure to specific embodiments, and it should be understood that various modifications, equivalents, and/or alternatives of the embodiments of the present disclosure are included.

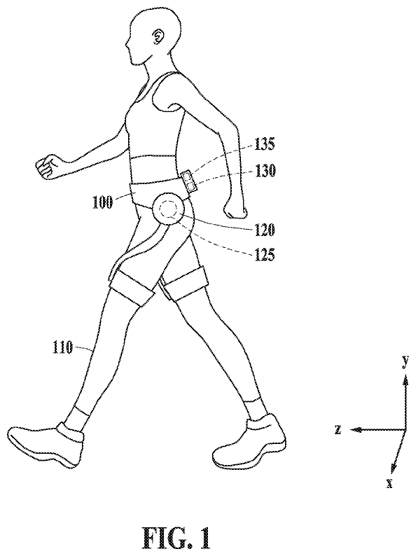

FIG. 1 is a diagram illustrating an overview of a wearable device worn on a body of a user, according to an embodiment.

Referring to FIG. 1, in an embodiment, a wearable device 100 may be a device worn on a body of a user 110 to assist the user 110 in walking, exercising, and/or working. In an embodiment, the wearable device 100 may be used to measure a physical ability (e.g., a walking ability, an exercise ability, or an exercise posture) of the user 110. In embodiments, the term “wearable device” may be replaced with “wearable robot”, “walking assistance device”, or “exercise assistance device”. The user 110 may be a human or an animal, but is not limited thereto. The wearable device 100 may be worn on a body (e.g., a lower body (legs, ankles, knees, and the like), an upper body (torso, arms, wrists, and the like), or waist) of the user 110 and may apply an external force, such as an assistance force and/or a resistance force to a body motion of the user 110. The assistance force may be a force assisting the body motion of the user 110, which is applied in the same direction as a direction of the body motion of the user 110. The resistance force may be a force applied in a direction opposite to the direction of the body motion of the user 110, representing a force that hinders the body motion of the user 110. The term “resistance force” may also be referred to as “exercise load”.

In an embodiment, the wearable device 100 may operate in a walking assistance mode for assisting the user 110 in walking. In the walking assistance mode, the wearable device 100 may assist the user 110 in walking by applying an assistance force generated by a driving module 120 of the wearable device to the body of the user 110. The wearable device 100 may expand a walking ability of the user 110 by providing a force required for the user 110 to walk, thereby allowing the user 110 to walk independently or to walk for a long time. The wearable device 100 may help improve walking of a pedestrian whose walking habits or walking posture are abnormal.

In an embodiment, the wearable device 100 may operate in an exercise assistance mode to enhance the exercise effect of the user 110. In the exercise assistance mode, the wearable device 100 may hinder a body motion of the user 110 or provide resistance to a body motion of the user 110 by applying a resistance force generated by the driving module 120 to the body of the user 110. When the wearable device 100 is a hip-type wearable device that is worn on a waist (or pelvis) and legs (e.g., thighs) of the user 110, the wearable device 100 may provide an exercise load to a leg motion of the user 110 while being worn on the legs, thereby enhancing the exercise effect on the legs of the user 110. In an embodiment, the wearable device 100 may apply an assistance force to the body of the user 110 to assist the user 110 in exercising. For example, when a person with a disability or an elderly person desires to exercise by wearing the wearable device 100, the wearable device 100 may provide an assistance force to assist a body motion during the exercise. In an embodiment, the wearable device 100 may provide an assistance force and a resistance force in combination for each exercise section or time section, such as providing an assistance force in some exercise sections and a resistance force in other exercise sections.

In an embodiment, the wearable device 100 may operate in a physical ability measurement mode to measure a physical ability of the user 110. The wearable device 100 may measure motion information of the user 110 using sensors (e.g., an angle sensor 125 and an inertial measurement unit (IMU) 135) provided in the wearable device 100 while the user 110 is walking or exercising, and evaluate the physical ability of the user 110 based on the measured motion information. For example, a gait index or an exercise ability indicator (e.g., muscular strength, endurance, balance, or exercise posture) of the user 110 may be estimated based on the motion information of the user 110 measured by the wearable device 100. The physical ability measurement mode may include an exercise posture measurement mode to measure an exercise posture of the user 110.

In various embodiments of the present disclosure, for convenience of description, the wearable device 100 is described as an example of a hip-type wearable device, as illustrated in FIG. 1, but the embodiments are not limited thereto. As described above, the wearable device 100 may be worn on body parts (e.g., upper arms, lower arms, hands, calves, and feet) other than the waist and legs (particularly, the thighs), and the shape and configuration of the wearable device 100 may vary depending on the body part on which the wearable device 100 is worn.

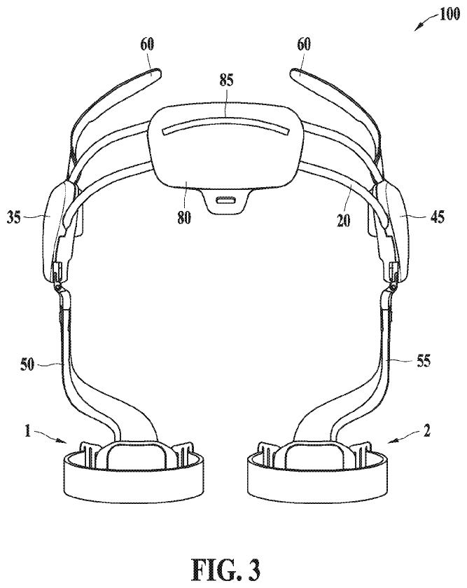

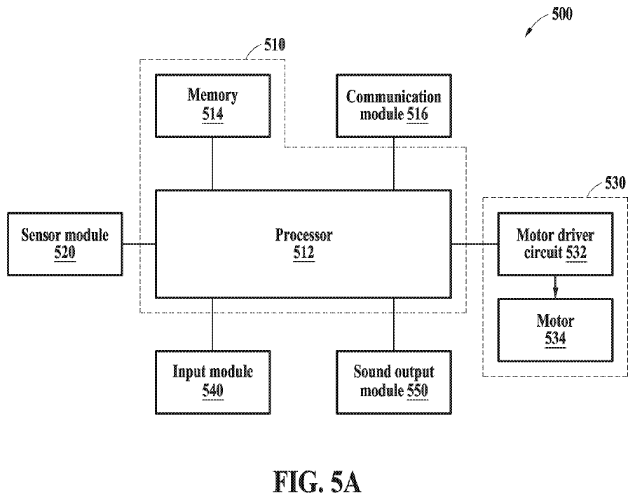

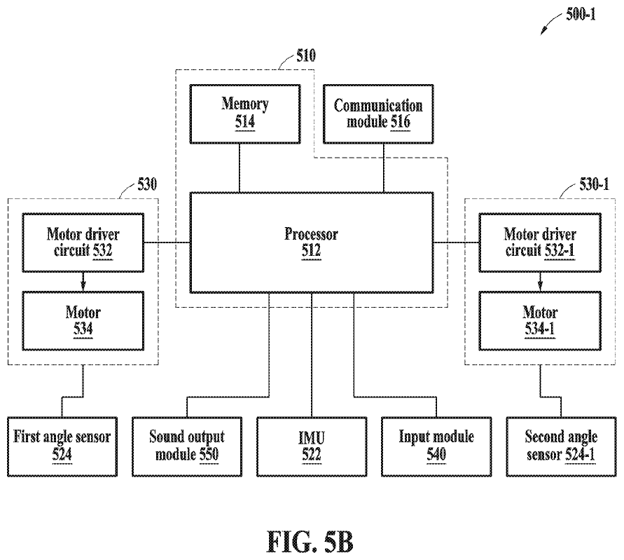

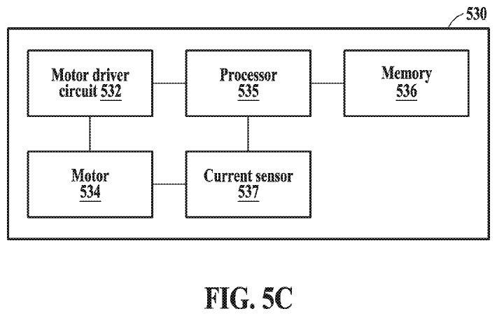

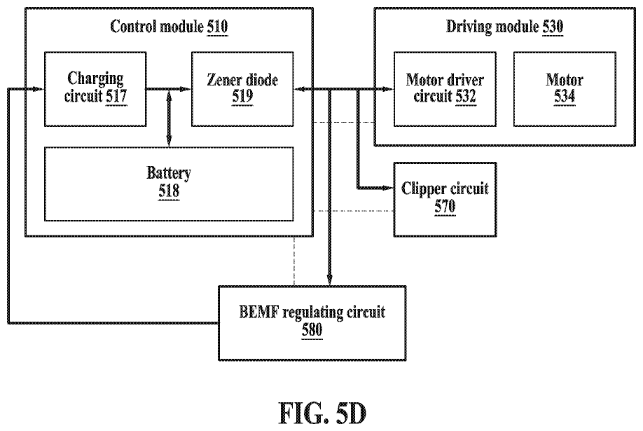

According to an embodiment, the wearable device 100 may include a support frame (e.g., leg support frames 50 and 55 and a waist support frame 20 of FIG. 3) configured to support the body of the user 110 when the wearable device 100 is worn on the body of the user 110, a sensor module (e.g., a sensor module 520 of FIG. 5A) configured to acquire sensor data including motion information about a body motion (e.g., a leg motion and an upper body motion) of the user 110, the driving module 120 (e.g., driving modules 35 and 45 of FIG. 3) configured to generate torque to be applied to the legs of the user 110, and a control module 130 (e.g., a control module 510 of FIGS. 5A and 5B) configured to control the wearable device 100.

The sensor module may include the angle sensor 125 and the IMU 135. The angle sensor 125 may measure a rotation angle of a leg support frame of the wearable device 100 corresponding to a hip joint angle value of the user 110. The rotation angle of the leg support frame measured by the angle sensor 125 may be estimated as the hip joint angle value (or leg angle value) of the user 110. The angle sensor 125 may include, for example, an encoder and/or a Hall sensor. In an embodiment, the angle sensor 125 may be located near a right hip joint and a left hip joint of the user 110, respectively. The IMU 135 may include an acceleration sensor and/or an angular velocity sensor, and measure a change in acceleration and/or angular velocity according to a motion of the user 110. The IMU 135 may measure, for example, an upper body motion value of the user 110 corresponding to a motion value of a waist support frame (or a base body (a base body 80 of FIG. 3)) of the wearable device 100. The motion value of the waist support frame measured by the IMU 135 may be estimated as the upper body motion value of the user 110.

In an embodiment, the control module 130 and the IMU 135 may be arranged within the base body (e.g., the base body 80 of FIG. 3) of the wearable device 100. The base body may be positioned on a lumbar region (an area of the lower back) of the user 110 while the user 110 is wearing the wearable device 100. The base body may be formed or attached to an outer side of the waist support frame of the wearable device 100. The base body may be mounted on the lumbar region of the user 110 to provide a cushioning feeling to the lower back of the user 110 and may support the lower back of the user 110 together with the waist support frame.

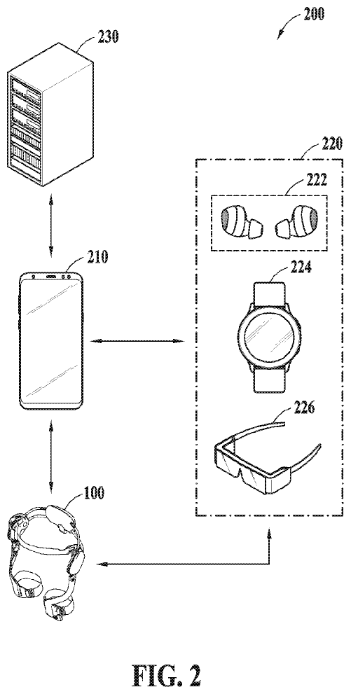

FIG. 2 is a diagram illustrating an exercise management system including a wearable device and an electronic device, according to an embodiment.

Referring to FIG. 2, an exercise management system 200 may include the wearable device 100 to be worn on a body of a user, an electronic device 210, another wearable device 220, and a server 230. In an embodiment, at least one (e.g., the other wearable device 220 or the server 230) of the above-described devices may be omitted from the exercise management system 200, or one or more other devices (e.g., an exclusive controller device of the wearable device 100) may be added thereto.

In an embodiment, the wearable device 100 may be worn on the body of the user in a walking assistance mode to assist a motion of the user. For example, the wearable device 100 may be worn on legs of the user to help the user in walking by generating an assistance force for assisting a leg motion of the user.

In an embodiment, the wearable device 100 may generate a resistance force to hinder a body motion of the user or an assistance force to assist a body motion of the user, and apply the generated resistance force or assistance force to the body of the user to enhance the exercise effect of the user in an exercise assistance mode. In the exercise assistance mode, the user may select, through the electronic device 210, an exercise program (e.g., squat, split lunge, dumbbell squat, lunge and knee up, stretching, and the like) to perform using the wearable device 100 and/or an exercise intensity to be applied to the wearable device 100. The wearable device 100 may control a driving module of the wearable device 100 according to the exercise program selected by the user, and acquire sensor data including motion information of the user through a sensor module. The wearable device 100 may adjust the strength of the resistance force or assistance force applied to the user based on the exercise intensity selected by the user. For example, the wearable device 100 may control the driving module to generate a resistance force corresponding to the exercise intensity selected by the user.

In an embodiment, the wearable device 100 may be used to measure a physical ability of the user by interworking with the electronic device 210. The wearable device 100 may operate in a physical ability measurement mode, which is a mode for measuring the physical ability of the user under a control of the electronic device 210, and may transmit sensor data acquired by a motion of the user in the physical ability measurement mode to the electronic device 210. The electronic device 210 may estimate the physical ability of the user by analyzing the sensor data received from the wearable device 100.

The electronic device 210 may communicate with the wearable device 100 and may remotely control the wearable device 100 or provide the user with state information about a state (e.g., a booting state, a charging state, a sensing state, and an error state) of the wearable device 100. The electronic device 210 may receive the sensor data acquired by a sensor of the wearable device 100 from the wearable device 100, and estimate the physical ability of the user or an exercise result based on the received sensor data. In an embodiment, when the user exercises while wearing the wearable device 100, the wearable device 100 may acquire sensor data including motion information of the user using sensors and may transmit the acquired sensor data to the electronic device 210. The electronic device 210 may extract a motion value of the user from the sensor data and evaluate an exercise posture of the user based on the extracted motion value. The electronic device 210 may provide the user with an exercise posture measured value and exercise posture evaluation information related to the exercise posture of the user through a graphical user interface.

In an embodiment, the electronic device 210 may execute a program (e.g., an application) configured to control the wearable device 100, and the user may adjust an operation or a set value of the wearable device 100 (e.g., a torque intensity output from the driving module (e.g., the driving modules 35 and 45 of FIG. 3), the volume of audio output from a sound output module (e.g., a sound output module 550 of FIGS. 5A and 5B), and the brightness of a lighting unit (e.g., a lighting unit 85 of FIG. 3)) through the program. The program executed by the electronic device 210 may provide a graphical user interface (GUI) for interaction with the user. The electronic device 210 may include various types of devices. For example, the electronic device 210 may include a portable communication device (e.g., a smartphone), a computer device, an access point, a portable multimedia device, or a home appliance (e.g., a television, an audio device, and a projector device), but is not limited thereto.

According to an embodiment, the electronic device 210 may be connected to the server 230 using short-range wireless communication or cellular communication. The server 230 may receive user profile information of the user who uses the wearable device 100 from the electronic device 210, and store and manage the received user profile information. The user profile information may include, for example, information about at least one of a name, age, gender, height, weight, or body mass index (BMI). The server 230 may receive exercise history information about an exercise performed by the user from the electronic device 210, and store and manage the received exercise history information. The server 230 may provide the electronic device 210 with various exercise programs or physical ability measurement programs that may be provided to the user.

According to an embodiment, the wearable device 100 and/or the electronic device 210 may be connected to the other wearable device 220. The other wearable device 220 may be, for example, wireless earphones 222, a smartwatch 224, or smart glasses 226, but is not limited thereto. In an embodiment, the smartwatch 224 may measure a biosignal including heart rate information of the user and transmit the measured biosignal to the electronic device 210 and/or the wearable device 100. The electronic device 210 may estimate heart rate information (e.g., a current heart rate, a maximum heart rate, and an average heart rate) of the user based on the biosignal received from the smartwatch 224 and provide the estimated heart rate information to the user.

In an embodiment, the exercise result information, physical ability information, and/or exercise posture evaluation information of the user that are evaluated by the electronic device 210 may be transmitted to the other wearable device 220 and provided to the user through the other wearable device 220. The state information of the wearable device 100 may also be transmitted to the other wearable device 220 and provided to the user through the other wearable device 220. In an embodiment, the wearable device 100, the electronic device 210, and the other wearable device 220 may be connected to each other via wireless communication (e.g., Bluetooth™ communication or wireless fidelity (Wi-Fi) communication).

In an embodiment, the wearable device 100 may provide (or output) feedback (e.g., visual feedback, auditory feedback, and haptic feedback) corresponding to a state of the wearable device 100 according to a control signal received from the electronic device 210. For example, the wearable device 100 may provide visual feedback through the lighting unit (e.g., the lighting unit 85 of FIG. 3) and auditory feedback through the sound output module (e.g., the sound output module 550 of FIGS. 5A and 5B). The wearable device 100 may include a haptic module, and provide haptic feedback in the form of vibration to the body of the user through the haptic module. The electronic device 210 may also provide (or output) feedback (e.g., visual feedback, auditory feedback, and haptic feedback) corresponding to the state of the wearable device 100.

In an embodiment, the electronic device 210 may present a personalized exercise goal to the user in the exercise assistance mode. The personalized exercise goal may include respective target amounts of exercise for exercise types (e.g., strength exercise, balance exercise, and aerobic exercise) desired by the user, determined by the electronic device 210 and/or the server 230. When the server 230 determines a target amount of exercise, the server 230 may transmit information about the determined target amount of exercise to the electronic device 210. The electronic device 210 may personalize and present the target amounts of exercise for the exercise types, such as strength exercise, aerobic exercise, and balance exercise, according to a desired exercise program (e.g., squat, split lunge, or a lunge and knee up) and/or physical characteristics (e.g., age, height, weight, and BMI) of the user. The electronic device 210 may display a GUI screen displaying the target amounts of exercise for the respective exercise types on a display.

In an embodiment, the electronic device 210 and/or the server 230 may include a database in which information about a plurality of exercise programs to be provided to the user through the wearable device 100 is stored. To achieve an exercise goal of the user, the electronic device 210 and/or the server 230 may recommend an exercise program suitable for the user. The exercise goal may include, for example, at least one of muscle strength improvement, physical strength improvement, cardiovascular endurance improvement, core stability improvement, flexibility improvement, or symmetry improvement. The electronic device 210 and/or the server 230 may store and manage the exercise program performed by the user, results of the exercise program, and the like.

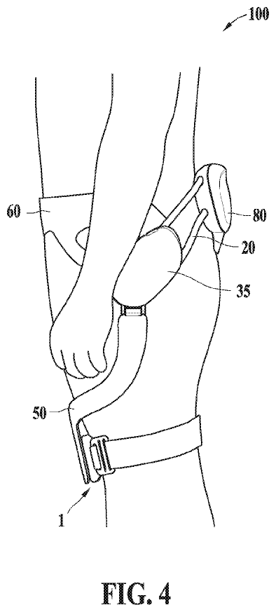

FIG. 3 is a rear schematic view of a wearable device, according to an embodiment. FIG. 4 is a left side view of a wearable device, according to an embodiment.

Referring to FIGS. 3 and 4, the wearable device 100, according to an embodiment, may include the base body 80, the waist support frame 20, the driving modules 35 and 45, the leg support frames 50 and 55, thigh-fastening portions 1 and 2, and a waist-fastening portion 60. The base body 80 may include the lighting unit 85. In an embodiment, at least one (e.g., the lighting unit 85) of the components described above may be omitted from the wearable device 100, or one or more other components (e.g., a haptic module) may be added to the wearable device 100.

The base body 80 may be disposed on, directly or indirectly, the lumbar region of a user while the user is wearing the wearable device 100. The base body 80 may be mounted on the lumbar region of the user to provide a cushioning feeling to a lower back of the user and may support the lower back of the user. The base body 80 may be hung on a hip region (an area of the hips) of the user to prevent the wearable device 100 from being separated downward due to gravity while the user is wearing the wearable device 100. The base body 80 may distribute a portion of a weight of the wearable device 100 to the lower back of the user while the user is wearing the wearable device 100. The base body 80 may be connected, directly or indirectly, to the waist support frame 20. Waist support frame connecting elements (not shown) to be connected, directly or indirectly, to the waist support frame 20 may be provided at both ends of the base body 80.

In an embodiment, the lighting unit 85 may be arranged on an outer side of the base body 80. The lighting unit 85 may include a light source (e.g., a light-emitting diode (LED)) The lighting unit 85 may emit light under a control of a control module (not shown) (e.g., the control module 510 of FIGS. 5A and 5B). According to embodiments, the control module may control the lighting unit 85 to provide (or output) visual feedback corresponding to a state of the wearable device 100 to the user through the lighting unit 85.

The waist support frame 20 may extend from both ends of the base body 80. The lumbar region of the user may be accommodated inside the waist support frame 20. The waist support frame 20 may include at least one rigid body beam. Each beam may be a curved shape having a preset curvature to enclose the lumbar region of the user. The waist-fastening portion 60 may be connected, directly or indirectly, to an end of the waist support frame 20. The driving modules 35 and 45 may be connected, directly or indirectly, to the waist support frame 20.

In an embodiment, the control module, an IMU (not shown) (e.g., the IMU 135 of FIG. 1 or an IMU 522 of FIG. 5B), a communication module (not shown) (e.g., a communication module 516 of FIGS. 5A and 5B), and a battery (not shown) may be arranged inside the base body 80. The base body 80 may protect the control module, the IMU, the communication module, and the battery. The control module may generate a control signal for controlling the operation of the wearable device 100. The control module may include a control circuit including a processor configured to control actuators of the driving modules 35 and 45 and a memory. The control module may further include a power supply module (not shown) configured to supply power from the battery to each of the components of the wearable device 100.

In an embodiment, the wearable device 100 may include a sensor module (not shown) (e.g., the sensor module 520 of FIG. 5A) configured to acquire sensor data from at least one sensor. The sensor module may acquire sensor data that changes according to a motion of the user. In an embodiment, the sensor module may acquire sensor data including motion information of the user and/or motion information of the components of the wearable device 100. The sensor module may include, for example, an IMU (e.g., the IMU 135 of FIG. 1 or the IMU 522 of FIG. 5B) configured to measure an upper body motion value of the user or a motion value of the waist support frame 20, and an angle sensor (e.g., the angle sensor 125 of FIG. 1 or a first angle sensor 524 and a second angle sensor 524-1 of FIG. 5B) configured to measure a hip joint angle value of the user or a motion value of the leg support frames 50 and 55, but is not limited thereto. For example, the sensor module may further include at least one of a position sensor, a temperature sensor, a biosignal sensor, or a proximity sensor.

The waist-fastening portion 60 may be connected, directly or indirectly, to the waist support frame 20 to fasten the waist support frame 20 to a waist of the user. The waist-fastening portion 60 may include, for example, one or a pair of belts.

The driving modules 35 and 45 may generate an external force (or torque) to be applied to the body of the user based on the control signal generated by the control module. For example, the driving modules 35 and 45 may generate an assistance force or resistance force to be applied to the legs of the user. In an embodiment, the driving modules 35 and 45 may include a first driving module 45 disposed in a position corresponding to a position of a right hip joint of the user, and a second driving module 35 disposed in a position corresponding to a position of a left hip joint of the user. The first driving module 45 may include a first actuator and a first joint member, and the second driving module 35 may include a second actuator and a second joint member. The first actuator may provide power to be transmitted to the first joint member, and the second actuator may provide power to be transmitted to the second joint member. The first actuator and the second actuator may each include a motor configured to generate power (or torque) by receiving electric power from the battery. When the motor is supplied with electric power and driven, the motor may generate a force (an assistance force) for assisting a body motion of the user or a force (a resistance force) for hindering a body motion of the user. In an embodiment, the control module may adjust the strength and direction of the force generated by the motor by adjusting the voltage and/or current supplied to the motor.

In an embodiment, the first joint member and the second joint member may receive power from the first actuator and the second actuator, respectively, and may apply an external force to the body of the user based on the received power. The first joint member and the second joint member may be arranged at positions corresponding to joint portions of the user, respectively. One side of the first joint member may be connected, directly or indirectly, to the first actuator, and the other side of the first joint member may be connected, directly or indirectly, to the first leg support frame 55. The first joint member may be rotated by the power received from the first actuator. An encoder or a Hall sensor that may operate as an angle sensor to measure a rotation angle (corresponding to a joint angle of the user) of the first joint member may be disposed on one side of the first joint member. One side of the second joint member may be connected, directly or indirectly, to the second actuator, and the other side of the second joint member may be connected, directly or indirectly, to the second leg support frame 50. The second joint member may be rotated by the power received from the second actuator. An encoder or a Hall sensor that may operate as an angle sensor to measure a rotation angle of the second joint member may be disposed on one side of the second joint member.

In an embodiment, the first actuator may be arranged in a lateral direction of the first joint member, and the second actuator may be arranged in a lateral direction of the second joint member. A rotation axis of the first actuator and a rotation axis of the first joint member may be spaced apart from each other, and a rotation axis of the second actuator and a rotation axis of the second joint member may also be spaced apart from each other. However, embodiments are not limited thereto, and an actuator and a joint member may share a rotation axis. In an embodiment, each actuator may be spaced apart from a corresponding joint member. In this case, the driving modules 35 and 45 may further include a power transmission module (not shown) configured to transmit power from the actuator to the joint member. The power transmission module may be a rotary body, such as a gear, or a longitudinal member, such as a wire, a cable, a string, a spring, a belt, or a chain. However, the scope of the embodiment is not limited by the positional relationship between the actuator and the joint member and the power transmission structure described above.

In an embodiment, the leg support frames 50 and 55 may support a leg (e.g., a thigh) of the user when the wearable device 100 is worn on the leg of the user. The leg support frames 50 and 55 may transmit power (torque) generated by the driving modules 35 and 45 to the thigh of the user, and the power may function as an external force to be applied to a motion of the leg of the user. As one end portion of the leg support frames 50 and 55 is connected, directly or indirectly, to a joint member to rotate and the other end portion of the leg support frames 50 and 55 is connected to the thigh-fastening portions 1 and 2, the leg support frames 50 and 55 may transmit the power generated by the driving modules 35 and 45 to the thigh of the user while supporting the thigh of the user. For example, the leg support frames 50 and 55 may push or pull the thigh of the user. The leg support frames 50 and 55 may extend in a longitudinal direction of the thighs of the user. The leg support frames 50 and 55 may be bent to wrap around at least a portion of a circumference of the thighs of the user. The leg support frames 50 and 55 may include a first leg support frame 55 to support a right leg of the user, and a second leg support frame 50 to support a left leg of the user.

The thigh-fastening portions 1 and 2 may be connected, directly or indirectly, to the leg support frames 50 and 55 and may fasten the leg support frames 50 and 55 to the thighs. The thigh-fastening portions 1 and 2 may include a first thigh-fastening portion 2 to fasten the first leg support frame 55 to a right thigh of the user, and a second thigh-fastening portion 1 to fasten the second leg support frame 50 to a left thigh of the user.

In an embodiment, the first thigh-fastening portion 2 may include a first cover, a first fastening frame, and a first strap, and the second thigh-fastening portion 1 may include a second cover, a second fastening frame, and a second strap. The first cover and the second cover may apply torques generated by the driving modules 35 and 45 to the thighs of the user. The first cover and the second cover may be arranged on one sides of the thighs of the user to push or pull the thighs of the user. For example, the first cover and the second cover may be arranged on front surfaces of the thighs of the user. The first cover and the second cover may be arranged in the circumferential directions of the thighs of the user. The first cover and the second cover may extend to both sides from the other end portions of the leg support frames 50 and 55 and may include curved surfaces corresponding to the thighs of the user. One ends of the first cover and the second cover may be connected, directly or indirectly, to the fastening frames, and the other ends thereof may be connected, directly or indirectly, to the straps.

The first fastening frame and the second fastening frame may be arranged, for example, to surround at least some portions of the circumferences of the thighs of the user, thereby preventing the thighs of the user from being separated from the leg support frames 50 and 55. The first fastening frame may have a fastening structure that connects the first cover and the first strap, and the second fastening frame may have a fastening structure that connects the second cover and the second strap.

The first strap may enclose the remaining portion of the circumference of the right thigh of the user that is not covered by the first cover and the first fastening frame, and the second strap may enclose the remaining portion of the circumference of the left thigh of the user that is not covered by the second cover and the second fastening frame. The first strap and the second strap may include, for example, an elastic material (e.g., a band).

FIGS. 5A and 5B are diagrams illustrating a configuration of a control system of a wearable device, according to an embodiment.

Referring to FIG. 5A, the wearable device 100 may be controlled by a control system 500. The control system 500 may include the control module 510, the communication module 516, the sensor module 520, a driving module 530, an input module 540, and the sound output module 550. In an embodiment, at least one (e.g., the sound output module 550) of the components described above may be omitted from the control system 500, or one or more other components (e.g., a haptic module) may be added to the control system 500.

The driving module 530 may include a motor 534 configured to generate power (e.g., torque), and a motor driver circuit 532 to drive the motor 534. Although FIG. 5A illustrates the driving module 530 including one motor driver circuit 532 and one motor 534, the example of FIG. 5A is merely an example. Referring to FIG. 5B, a control system 500-1 shown in FIG. 5B may include a plurality of (e.g., two or more) motor driver circuits 532 and 532-1 and a plurality of (e.g., two or more) motors 534 and 534-1. The driving module 530 including the motor driver circuit 532 and the motor 534 may correspond to the first driving module 45 of FIG. 3, and a driving module 530-1 including the motor driver circuit 532-1 and the motor 534-1 may correspond to the second driving module 35 of FIG. 3. The following descriptions of the motor driver circuit 532 and the motor 534 may also be respectively applicable to the motor driver circuit 532-1 and the motor 534-1 illustrated in FIG. 5B.

Referring back to FIG. 5A, the sensor module 520 may include a sensor circuit including at least one sensor. The sensor module 520 may include sensor data including motion information of a user or motion information of the wearable device 100. The sensor module 520 may transmit the acquired sensor data to the control module 510. The sensor module 520 may include the IMU 522 and an angle sensor (e.g., the first angle sensor 524 and the second angle sensor 524-1) as illustrated in FIG. 5B. The IMU 522 may measure an upper body motion value of the user. For example, the IMU 522 may sense X-axis, Y-axis, and Z-axis accelerations and X-axis, Y-axis, and Z-axis angular velocities according to a motion of the user. The IMU 522 may be used to measure, for example, at least one of a forward and backward tilt, a left and right tilt, or a rotation of the body of the user. In addition, the IMU 522 may acquire motion values (e.g., acceleration values and angular velocity values) of a waist support frame (e.g., the waist support frame 20 of FIG. 3) of the wearable device. The motion values of the waist support frame may correspond to upper body motion values of the user.

The angle sensor may measure a hip joint angle value according to a motion of a leg of the user. Sensor data that may be measured by the angle sensor may include, for example, a hip joint angle value of a right leg, a hip joint angle value of a left leg, and information on a direction of a motion of a leg. For example, the first angle sensor 524 of FIG. 5B may acquire the hip joint angle value of the right leg of the user, and the second angle sensor 524-1 may acquire the hip joint angle value of the left leg of the user. The first angle sensor 524 and the second angle sensor 524-1 may each include, for example, an encoder and/or a Hall sensor. Further, the angle sensors may acquire motion values of the leg support frames of the wearable device 100. For example, the first angle sensor 524 may acquire a motion value of the first leg support frame 55, and the second angle sensor 524-1 may acquire a motion value of the second leg support frame 50. The motion values of the leg support frames may correspond to the hip joint angle values.

In an embodiment, the sensor module 520 may further include at least one of a position sensor configured to acquire a position value of the wearable device 100, a proximity sensor configured to sense the proximity of an object, a biosignal sensor configured to detect a biosignal of the user, or a temperature sensor configured to measure an ambient temperature.

The input module 540 may receive a command or data to be used by another component (e.g., processor 512) of the wearable device 100 from the outside (e.g., the user) of the wearable device 100. The input module 540 may include an input component circuit. The input module 540 may include, for example, a key (e.g., a button) or a touch screen.

The sound output module 550 may output a sound signal to the outside of the wearable device 100. The sound output module 550 may provide auditory feedback to the user. For example, the sound output module 550 may include a speaker configured to play back a guiding sound signal (e.g., an operation start sound, an operation error alarm, and an exercise start alarm), music content, or a guiding voice for auditorily informing predetermined information (e.g., exercise result information or exercise posture evaluation information).

In an embodiment, the control system 500 may further include a battery (not shown) configured to supply power to each component of the wearable device 100. The wearable device 100 may convert the power of the battery into power suitable for an operating voltage of each component of the wearable device 100 and supply the converted power to each component.

The driving module 530 may generate external force to be applied to a leg of the user under a control of the control module 510. The driving module 530 may generate torque to be applied to the legs of the user based on a control signal generated by the control module 510. The control module 510 may transmit the control signal to the motor driver circuit 532. The motor driver circuit 532 may control the operation of the motor 534 by generating a current signal (or voltage signal) corresponding to the control signal and by supplying the generated current signal to the motor 534. In some cases, the current signal may not be supplied to the motor 534. When the motor 534 is supplied with the current signal and driven, the motor 534 may generate torque for an assistance force for assisting a leg motion of the user or a resistance force for hindering a leg motion of the user.

The control module 510 may control an overall operation of the wearable device 100 and may generate a control signal to control each component (e.g., the communication module 516 or the driving module 530). The control module 510 may include the processor 512 and a memory 514.

The processor 512 may execute, for example, software to control at least one other component (e.g., a hardware or software component) of the wearable device 100 connected to the processor 512, and may perform a variety of data processing or computation. The software may include an application for providing a GUI. According to an embodiment, as at least part of data processing or computation, the processor 512 may store instructions or data received from another component (e.g., the communication module 516) in the memory 514, process the instructions or the data stored in the memory 514, and store result data in the memory 514. According to an embodiment, the processor 512 may include a main processor (e.g., a central processing unit (CPU) or an application processor (AP)), or an auxiliary processor (e.g., a graphics processing unit (GPU), a neural processing unit (NPU), an image signal processor (ISP), a sensor hub processor, or a communication processor (CP)) that is operable independently of or in conjunction with the main processor. The auxiliary processor may be implemented separately from the main processor or as part of the main processor.

The memory 514 may store a variety of data used by at least one component (e.g., the processor 512) of the control module 510. The data may include, for example, software, sensor data, and input data or output data for instructions related thereto. The memory 514 may include a volatile memory or a non-volatile memory (e.g., random-access memory (RAM), dynamic RAM (DRAM), or static RAM (SRAM)).

The communication module 516 may support establishing a direct (e.g., wired) communication channel or a wireless communication channel between the control module 510 and another component of the wearable device 100 or an external electronic device (e.g., the electronic device 210 or the other wearable device 220 of FIG. 2), and performing communication via the established communication channel. The communication module 516 may include a communication circuit configured to perform a communication function. For example, the communication module 516 may receive a control signal from an electronic device (e.g., the electronic device 210) and transmit the sensor data acquired by the sensor module 520 to the electronic device. According to an embodiment, the communication module 516 may include one or more CPs (not shown) that are operable independently of the processor 512 and that support direct (e.g., wired) communication or wireless communication. According to an embodiment, the communication module 516 may include a wireless communication module (e.g., a cellular communication module, a short-range wireless communication module, or a global navigation satellite system (GNSS) communication module), and/or a wired communication module. A corresponding one of the above-described communication modules may communicate with another component of the wearable device 100 and/or the electronic device via a short-range communication network, such as Bluetooth™, wireless fidelity (Wi-Fi), or infrared data association (IrDA), or a long-range communication network, such as a legacy cellular network, a fifth generation (5G) network, a next-generation communication network, the Internet, or a computer network (e.g., a local area network (LAN) or a wide area network (WAN)).

In an embodiment, the control systems 500 and 500-1 may further include a haptic module (not shown). The haptic module may provide haptic feedback to the user under the control of the processor 512. The haptic module may convert an electrical signal into a mechanical stimulus (e.g., a vibration or a movement) or an electrical stimulus which may be recognized by a user via his or her tactile sensation or kinesthetic sensation. The haptic module may include a motor, a piezoelectric element, or an electrical stimulation device. In an embodiment, the haptic module may be positioned in at least one of the base body (e.g., the base body 80), the first thigh-fastening portion 2, or the second thigh-fastening portion 1.

FIG. 5C is a diagram illustrating a configuration of a driving module according to an embodiment.

According to an embodiment, the driving module 530 may include the motor driver circuit 532, the motor 534, a processor 535, a memory 536, and a current sensor 537.

According to an embodiment, the driving module 530 may include the processor 535 and the memory 536 that stores instructions executable by the processor 535. When the instructions are executed by the processor 535, the instructions may cause the driving module 530 to determine a state of the motor 534. For example, the processor 535 and the memory 536 may configure a micro controller unit (MCU).

The driving module 530 may further include the motor 534 and the current sensor 537. For example, the current sensor 537 may sense a value of current flowing through each of coils (e.g., three-phase coils) of the motor 534.

FIG. 5D is a diagram illustrating a configuration of a control module, a driving module, a clipper circuit, and a BEMF regulating circuit, according to an embodiment.

In the drawing, a thick solid line may indicate an electrical connection to which power is applied, and a dotted line may indicate an electrical connection in which a control signal is transmitted and received.

According to an embodiment, the control module 510 may include a charging circuit 517, a battery 518, and a diode 519. For example, the charging circuit 517 may include at least one of a wired charging module or a wireless charging module. The wired charging module may receive external power from an external power source connected through a wire such as a cable, and charge the battery 518 using the external power. The wireless charging module may charge the battery 518 through an inductive charging scheme or a scheme using electromagnetic waves.

The battery 518 and the driving module 530 may be electrically connected to each other through the diode 519, and current may flow from the battery 518 through the diode 519 to control the motor 534 of the driving module 530. In order to control the driving module 530, the diode 519 may not interfere with a current output from the charging circuit 517 or the battery 518 from proceeding from the control module 510 toward the driving module 530. On the other hand, the diode 519 may prevent a current for the power appearing in the driving module 530 from proceeding from the driving module 530 toward the control module 510. Since the power appearing in the driving module 530 does not affect the control module 510 due to the diode 519, the control module 510 may be protected.

When operating power for driving the motor 534 is supplied to the driving module 530 by the control module 510, the operating power may appear in the driving module 530. Additionally, when the user 110 moves while wearing the wearable device 100, the motor 534 may operate as a generator. When the motor 534 operates as a generator, BEMF may be generated within the driving module 530. For example, the operating power and BEMF may appear simultaneously within the driving module 530. The sum of the operating power and BEMF may be referred to as “combined power”. When the combined power is too large, there may be a possibility that components included in the driving module 530 may be damaged by the combined power.

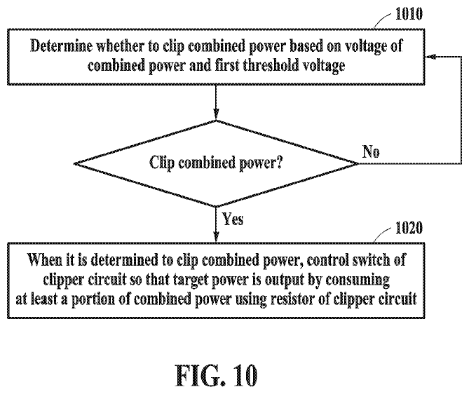

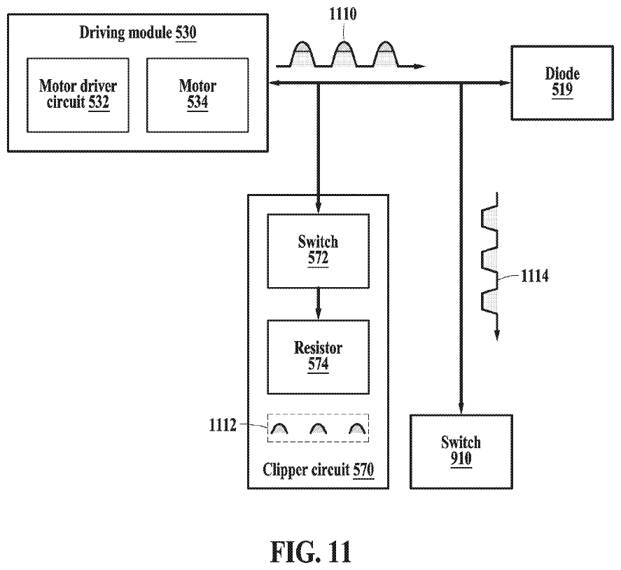

According to an embodiment, a clipper circuit 570 may consume at least a portion of the combined power appearing in the driving module 530. For example, the clipper circuit 570 may include a resistor, and at least a portion of the combined power may be consumed as heat by the resistor. The portion of the combined power consumed by the clipper circuit 570 may be referred to as “target power”. A method of generating the target power is described in detail below with reference to FIGS. 10 and 11.

According to an embodiment, when the combined power is of a magnitude that does not damage the components included in the driving module 530, the combined power may be treated as the target power. That is, when the combined power is of a magnitude that does not damage the components included in the driving module 530, the combined power may be defined as the target power even when at least a portion of the combined power is not consumed as heat.

According to an embodiment, the target power may be supplied to a BEMF regulating circuit. The BEMF regulating circuit may generate charging power by regulating or converting the target power. For example, the charging circuit 517 may charge the battery 518 using the charging power. For example, the charging circuit 517 may supply operating power to the driving module 530 using the charging power.

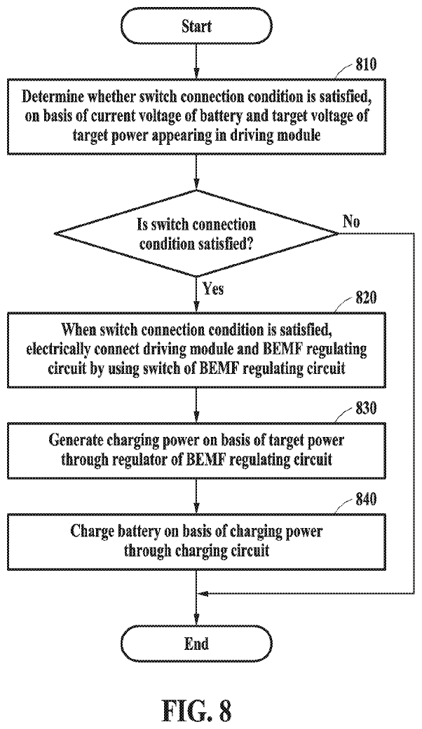

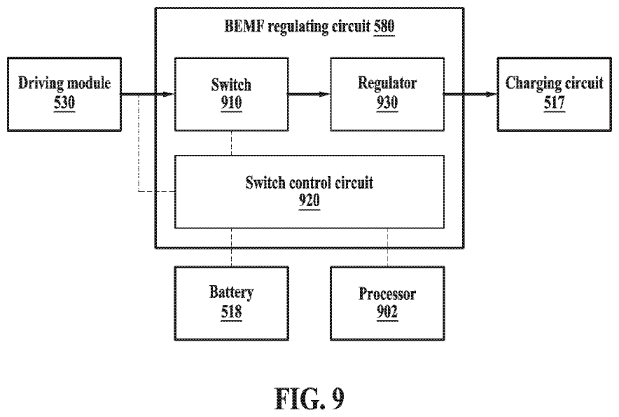

A method of generating the charging power and a method of charging a battery using the charging power are described in detail below with reference to FIGS. 8 and 9.

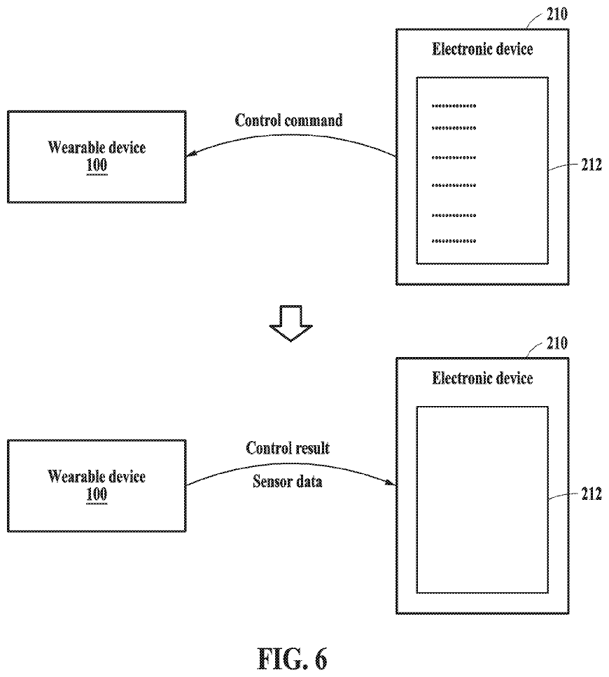

FIG. 6 is a diagram illustrating an interaction between a wearable device and an electronic device, according to an embodiment.

Referring to FIG. 6, the wearable device 100 may communicate with the electronic device 210. For example, the electronic device 210 may be a user terminal of a user using the wearable device 100 or a dedicated controller device for the wearable device 100. In an embodiment, the wearable device 100 and the electronic device 210 may be connected to each other through short-range wireless communication (e.g., Bluetooth™ communication or Wi-Fi communication).

In an embodiment, the electronic device 210 may check a state of the wearable device 100 or execute an application to control or operate the wearable device 100. A screen of a user interface (UI) may be displayed to control an operation of the wearable device 100 or determine an operation mode of the wearable device 100 on a display 212 of the electronic device 210 through the execution of the application. The UI may be, for example, a GUI.

In an embodiment, the user may input a command (e.g., an execution command to a walking assistance mode, an exercise assistance mode, or a physical ability measurement mode) for controlling the operation of the wearable device 100 or change settings of the wearable device 100 through a GUI screen on the display 212 of the electronic device 210. The electronic device 210 may generate a control command (or control signal) corresponding to an operation control command or a setting change command input by the user and transmit the generated control command to the wearable device 100. The wearable device 100 may operate according to the received control command and may transmit a control result according to the received control command and/or sensor data sensed by a sensor module of the wearable device 100 to the electronic device 210. The electronic device 210 may provide the user with result information (e.g., gait ability information, exercise ability information, and exercise posture evaluation information) derived by analyzing the control result and/or the sensor data through the GUI screen.

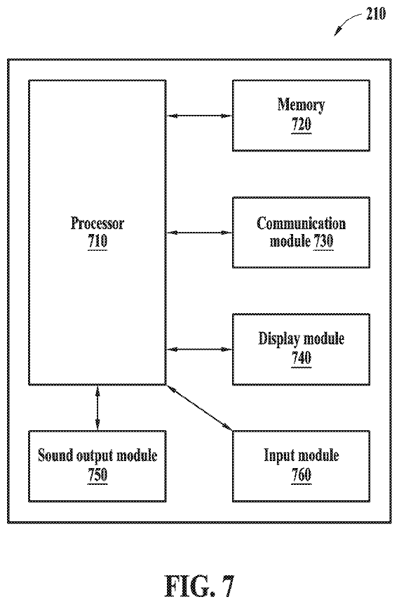

FIG. 7 is a diagram illustrating a configuration of an electronic device, according to an embodiment.

Referring to FIG. 7, the electronic device 210 may include a processor 710, memory 720, a communication module 730, a display module 740, a sound output module 750, and an input module 760. In an embodiment, at least one (e.g., the sound output module 750) of the components described above may be omitted from the electronic device 210, or one or more other components (e.g., a sensor module and a battery) may be added to the electronic device 210.

The processor 710 may control at least one other component (e.g., a hardware or software component) of the electronic device 210, and may perform a variety of data processing or computation. According to an embodiment, as at least part of data processing or computation, the processor 710 may store instructions or data received from another component (e.g., the communication module 730) in the memory 720, process the instructions or data stored in the memory 720, and store result data in the memory 720.

In an embodiment, the processor 710 may include a main processor (e.g., a CPU or an AP) or an auxiliary processor (e.g., a GPU, an NPU, an ISP, a sensor hub processor, or a CP) that is operable independently of or in conjunction with the main processor.

The memory 720 may store a variety of data used by at least one component (e.g., the processor 710 or the communication module 730) of the electronic device 210. The data may include, for example, a program (e.g., an application) and input data or output data for instructions related thereto. The memory 720 may include at least one instruction executable by the processor 710. The memory 720 may include, for example, a volatile memory or a non-volatile memory.

The communication module 730 may support establishing a direct (e.g., wired) communication channel or a wireless communication channel between the electronic device 210 and another electronic device (e.g., the wearable device 100, the other wearable device 220, and the server 230), and performing communication via the established communication channel. The communication module 730 may include a communication circuit configured to perform a communication function. The communication module 730 may include one or more CPs that are operable independently of the processor 710 (e.g., an AP) and that support direct (e.g., wired) communication or wireless communication. According to an embodiment, the communication module 290 may include a wireless communication module configured to perform wireless communication (e.g., a Bluetooth™ communication module, a cellular communication module, a Wi-Fi communication module, or a GNSS communication module) or a wired communication module (e.g., a LAN communication module or a power line communication (PLC) module). For example, the communication module 730 may transmit a control command to the wearable device 100 and may receive, from the wearable device 100, at least one of sensor data including body motion information of a user wearing the wearable device 100, state data of the wearable device 100, or control result data corresponding to the control command.

The display module 740 may visually provide information to the outside (e.g., a user) of the electronic device 210. The display module 740 may include, for example, a liquid crystal display (LCD) or organic light-emitting diode (OLED) display, a hologram device, or a projector device. The display module 740 may further include a control circuit configured to control the driving of a display. In an embodiment, the display module 740 may further include a touch sensor adapted to sense a touch, or a pressure sensor adapted to measure an intensity of a force incurred by the touch.

The sound output module 750 may output sound signals to the outside of the electronic device 210. The sound output module 750 may include a guiding sound signal (e.g., a driving start sound or an operation error notification sound) based on a state of the wearable device 100 and a speaker for playing musical content or a guiding voice. When it is determined that the wearable device 100 is not properly worn on a body of the user, for example, the sound output module 750 may output a guiding voice for informing the user is wearing the wearable device 100 abnormally or for guiding the user to wear the wearable device 100 normally. The sound output module 750 may output, for example, a guiding voice corresponding to exercise evaluation information or exercise result information acquired by evaluating an exercise of the user.

The input module 760 may receive a command or data to be used by another component (e.g., the processor 710) of the electronic device 210, from the outside (e.g., a user) of the electronic device 210. The input module 760 may include an input component circuit and may receive a user input. The input module 760 may include, for example, a key (e.g., a button) or a touch screen.

FIG. 8 is a flowchart of a method of charging a battery, according to an embodiment.

The following operations 810 to 840 may be performed by a wearable device (e.g., the wearable device 100 described above with reference to FIGS. 1 to 7). For example, the wearable device may include at least one processor and memory storing instructions.

For example, the at least one processor may include at least one of the processor 512 of FIG. 5A, the processor 535 of FIG. 5C, a processor of the charging circuit 517 or a processor of the battery 518 of FIG. 5D. The processor of the charging circuit 517 may be a processor that controls an operation of the charging circuit 517. The processor of the battery 518 may be a processor that controls the charging and discharging of the battery 518.

The memory of the wearable device 100 may be configured collectively or configured in a distributed manner. Instructions stored in the memory may be stored collectively or configured in a distributed manner. The instructions may be executed by the at least one processor individually or collectively, and functions of the wearable device may be performed by the execution of the instructions.

In operation 810, the wearable device may determine whether a switch connection condition is satisfied based on a target voltage of target power appearing in a driving module (e.g., the driving module 530 of FIG. 5D) and a current voltage of a battery (e.g., the battery 518 of FIG. 5D).

The target power may be power appearing in a motor driver circuit (e.g., the motor driver circuit 532 of FIG. 5D) or a motor (e.g., the motor 534 of FIG. 5D) of the driving module. For example, when the motor operates as a generator, the target power may correspond to or include BEMF generated by the motor. For example, the target power may include at least a portion of operating power supplied to the driving module by a control module (e.g., the control module 510 of FIG. 5D). For example, a voltage of the target power may be less than 60 volt (V), but not limited thereto.

According to an embodiment, the target power may correspond to power after at least a portion of combined power appearing in the driving module is consumed. For example, a voltage of the combined power appearing in the driving module may be greater than or equal to 60 V. When a voltage of the combined power greater than a voltage (or current) that components of the driving module may withstand is applied, the components of the driving module may be damaged. To prevent damage to the components of the driving module, the wearable device may lower the voltage (or current) applied to the driving module by consuming at least a portion of the combined power. A method of consuming at least a portion of the combined power is described in detail below with reference to FIGS. 10 and 11.

The wearable device may sense a current voltage of the battery. The current voltage of the battery may be a basis for calculating a state of charge (SOC) of the battery. For example, a voltage range of the battery may be from 10 V to 17 V. The voltage range of the battery may correspond to the range of an operating voltage of the motor. When the SOC of the battery is 100%, the current voltage of the battery may correspond to a maximum voltage, and when the SOC of the battery is 0%, the current voltage of the battery may correspond to a minimum voltage. When the SOC of the battery is 0%, the wearable device may turn off power to protect a control system (e.g., the control system 500 of FIG. 5A) and the battery of the wearable device.

According to an embodiment, the wearable device may determine whether the switch connection condition is satisfied based on the target voltage of the target power appearing in the driving module and the current voltage of the battery. For example, when the target voltage of the target power is within a first range and the current voltage of the battery is within a second range, it may be determined that the switch connection condition is satisfied.

An upper voltage of the first range for the target voltage may be set to correspond to a voltage that the components of the driving module or BEMF regulating circuit (e.g., a BEMF regulating circuit 580 of FIG. 5D) may withstand. When the target voltage is low, BEMF may not appear in the motor. Even when BEMF is not generated by the motor, when the target power is supplied to the BEMF regulating circuit, power stored in the battery that should be supplied to the driving module may not be supplied to the driving module. To prevent a situation where operating power is not supplied to the driving module, a lower voltage of the first range may be set to correspond to a voltage at which the wearable device may determine that BEMF has appeared in the driving module.

In a case where the current voltage of the battery is outside the second range, when the current voltage of the battery exceeds the upper voltage of the second range, the SOC of the battery may exceed 100%. To prevent overcharging of the battery, it may be determined that the switch connection condition is not satisfied.

In the case where the current voltage of the battery is outside the second range, when the current voltage of the battery is less than the lower voltage of the second range, the SOC of the battery may be less than a threshold SOC. When the SOC of the battery is less than the threshold SOC, it may be determined that the switch connection condition is not satisfied to prevent malfunction of the wearable device. For example, the threshold SOC may be a value of 10% or less, but is not limited thereto.

According to an embodiment, the wearable device may determine whether the switch connection condition is satisfied based on a current state of the wearable device. For example, the current state of the wearable device may be a state in which a mode for charging the battery based on BEMF is activated. For example, the current state of the wearable device may include at least one of a temperature state, a humidity state, an immersion state, a vibration state of the wearable device or the battery, or an operation mode of the wearable device. The temperature state, humidity state, immersion state, or vibration state of the wearable device or the battery may be sensed by a related sensor. For example, the operation mode of the wearable device may include at least one of a walking assistance mode, an exercise assistance mode, a physical ability measurement mode, and a freestyle mode. The freestyle mode may be a mode in which the wearable device does not output torque through the motor.

According to an embodiment, depending on the operation mode of the wearable device, at least one of the first range for the target voltage or the second range for the current voltage of the battery may be set differently. For example, in the freestyle mode, since operating power from the battery is not supplied to the driving module, even when the target power appearing in the driving module is supplied to the BEMF regulating circuit, the battery power may not be consumed.

According to an embodiment, the BEMF regulating circuit may include a switch control circuit configured to determine whether the switch connection condition is satisfied. For example, the switch control circuit may include a circuit configured to receive a target voltage of target power appearing in the driving module, a circuit configured to receive a current voltage of the battery, and a circuit configured to compare the target voltage of the target power with the current voltage of the battery. The switch control circuit may further include a circuit configured to receive a current state of the wearable device. The switch control circuit is described in detail below with reference to FIG. 9.

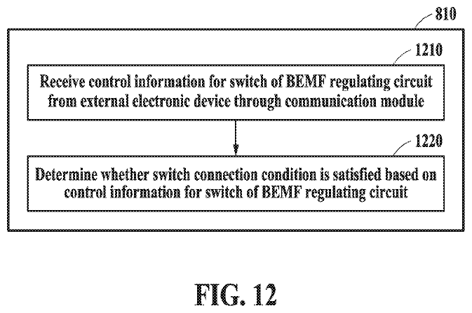

According to an embodiment, the wearable device may receive additional information from an external electronic device (e.g., the electronic device 2100 of FIG. 2) that is directly or indirectly connected to the wearable device, and determine whether a switch connection condition is satisfied based on the additional information. A method of receiving the additional information from an external electronic device to determine whether a switch connection condition is satisfied is described in detail below with reference to FIG. 12.

In operation 820, when the switch connection condition is satisfied, the wearable device may electrically connect the driving module to the BEMF regulating circuit using a switch of the BEMF regulating circuit. For example, when the switch of the BEMF regulating circuit is closed, the driving module and a regulator of the BEMF regulating circuit may be electrically connected to each other through at least the switch. As the driving module and the regulator are electrically connected, directly or indirectly, to each other, the target power appearing in the driving module may be input to the regulator.

When the switch connection condition is not satisfied, the switch of the BEMF regulating circuit may be controlled so that the driving module and the BEMF regulating circuit are not electrically connected to each other.

In operation 830, the wearable device may generate charging power based on the target power through a regulator (or a direct current (DC)/DC converter) of the BEMF regulating circuit. The regulator may regulate (or convert) the target power so that the generated charging power has a voltage value within a predetermined range. For example, a predetermined voltage range for charging power may correspond to a voltage range of external power received by a charging circuit (e.g., the charging circuit 517 of FIG. 5) from an external power source connected through a wired charging module to charge the battery. For example, the predetermined voltage range for the charging power may be less than or equal to 20 V. The charging power generated through the regulator may be supplied to the charging circuit.

In operation 840, the wearable device may charge the battery based on the charging power through the charging circuit. For example, the charging power may be considered as external power received from an external power source through a wire such as a cable.

Although operations 810 to 840 have been described as being able to be performed by a wearable device (e.g., the wearable device 100 described above with reference to FIGS. 1 to 7), operations 810 to 840 may be performed by an electronic device. For example, the electronic device may be a device including at least some of the components described with respect to the wearable device 100. For example, the electronic device may include the control module 510, the driving module 530, the clipper circuit 570, and the BEMF regulating circuit 580 described with reference to FIG. 5D.

FIG. 9 is a diagram illustrating a configuration of a BEMF regulating circuit, according to an embodiment.

According to an embodiment, the BEMF regulating circuit 580 of FIG. 5D may include a switch 910, a switch control circuit 920, and a regulator 930.

When the switch 910 is open, the driving module 530 and the regulator 930 may be electrically disconnected from each other, and when the switch 910 is closed, the driving module 530 and the regulator 930 may be electrically connected to each other. A connection state of the switch 910 may be controlled by the switch control circuit 920.

The switch control circuit 920 may include a circuit configured to receive a target voltage of target power appearing in the driving module 530. For example, the switch control circuit 920 may include a voltage divider circuit and may receive a target voltage appearing in the driving module 530 through the voltage divider circuit. The switch control circuit 920 may include a circuit configured to receive a current voltage of the battery 518. The switch control circuit 920 may include a circuit (e.g., a comparator) configured to compare the target voltage of the target power with the current voltage of the battery 518. The comparator may be a circuit that operates solely on hardware components.

The switch control circuit 920 may determine whether one or more predetermined conditions are satisfied for the target voltage of the target power and the current voltage of the battery 518 through at least one comparator. For example, it may be determined whether the target voltage of the target power is within a first range. For example, it may be determined whether the current voltage of the battery is within a second range.

The switch control circuit 920 may include an additional controller. For example, the controller may include an MCU or an AP. The controller of the switch control circuit 920 may receive the target voltage of the target power and the current voltage of the battery 518, and determine whether one or more predetermined conditions for the target voltage of the target power and the battery 518 are satisfied. Additional software may be used when the switch control circuit 920 uses an additional controller to determine whether one or more predetermined conditions for the target voltage of the target power and the battery 518 are satisfied.

The switch control circuit 920 may further include a circuit configured to receive a current state of the wearable device 100 from a processor 902. For example, the processor 902 may correspond to the processor 512 of FIG. 5A, the processor 535 of FIG. 5C, the processor of the charging circuit 517 or the processor of the battery 518 of FIG. 5D. For example, the current state of the wearable device 100 may include at least one of a temperature state, a humidity state, an immersion state, or a vibration state of the wearable device 100 or the battery 518, or an operation mode of the wearable device 100. When any one of the various measured states is in an unsuitable state to generate charging power using target power, the processor 902 may transmit a switch deactivation command to the switch control circuit 920.

According to an embodiment, the wearable device 100 may receive, through the communication module 516, additional information from an external electronic device (e.g., the electronic device 210 of FIG. 2) that is directly or indirectly connected to the wearable device 100, and determine whether a switch connection condition is satisfied based on the additional information. Whether the switch connection condition is satisfied based on the additional information may be input to the switch control circuit 920 through the processor 902.

According to an embodiment, the switch control circuit may include elements including one or more comparators and elements including an AND gate. For example, among the comparators, a first comparator may receive a first plurality of values for the first comparator and output a result of comparison of the first plurality of values as a first output value to the AND gate. For example, the first comparator may be a comparator configured to determine whether the target voltage of the target power is within the first range or a comparator configured to determine whether the current voltage of the battery 518 is within the second range. For example, when one or more switch connection conditions are all satisfied, all values of 1 (or, HIGH signals) may be input to the AND gate, and the AND gate may output a value of 1. Hereinafter, the value of 1 is written as “1”. When “1” is output by the AND gate, the switch 910 may be closed so that the driving module 530 and the regulator 930 are electrically connected to each other. For example, when at least one of the one or more switch connection conditions is not satisfied, at least one value of 0 (or, LOW signal) may be input to the AND gate, and the AND gate may output a value of 0. Hereinafter, the value of 0 is written as “0”. When “0” is output by the AND gate, the switch 910 may be opened so that the driving module 530 and the regulator 930 are electrically connected to each other.

FIG. 10 is a flowchart of a method of outputting target power by clipping combined power appearing in a driving module, according to an embodiment.

According to an embodiment, operations 1010 and 1020 may be performed before operation 810 described above with reference to FIG. 8 is performed. Operations 1010 and 1020 may be performed by a wearable device (e.g., the wearable device 100 described above with reference to FIGS. 1 to 7). For example, the wearable device may include at least one processor and memory storing instructions.

For example, the at least one processor may include at least one of the processor 512 of FIG. 5A, the processor 535 of FIG. 5C, the processor of the charging circuit 517 or the processor of the battery 518 of FIG. 5D.

The memory of the wearable device 100 may be configured collectively or configured in a distributed manner. Instructions stored in the memory may be stored collectively or configured in a distributed manner. The instructions may be executed by the at least one processor individually or collectively, and functions of the wearable device may be performed by the execution of the instructions.

In operation 1010, the wearable device may determine whether to clip combined power based on a voltage of the combined power appearing in a driving module (e.g., the driving module 530 of FIG. 5D and FIG. 9) and a first threshold voltage. The combined power may be power resulting from operating power supplied to the driving module and BEMF generated by a motor. For example, the first threshold voltage may correspond to a voltage that components of a BEMF regulating circuit (e.g., the BEMF regulating circuit 580 of FIG. 5D and FIG. 9) may withstand, or a voltage greater than that. The wearable device may determine whether a voltage of the combined power is excessively high based on the first threshold voltage.

According to an embodiment, when the voltage of the combined power is less than the first threshold voltage, the combined power may not be clipped. The unclipped combined power may be applied to a switch (e.g., the switch 910 of FIG. 9) of the BEMF regulating circuit as target power.

In operation 1020, when the wearable device determines to clip the combined power, the wearable device may control a switch of a clipper circuit so that the target power is output by consuming at least a portion of the combined power using a resistor of the clipper circuit. When the voltage of the combined power is less than the first threshold voltage, the switch of the clipper circuit may be open so that the driving circuit 530 and the resistor of the clipper circuit are not connected to each other. When the voltage of the combined power is greater than or equal to the first threshold voltage, the switch of the clipper circuit may be closed so that the driving circuit 530 and the resistor of the clipper circuit are connected to each other. For example, at least a portion of the combined power may be converted into heat by the resistor of the clipper circuit. As the portion of the combined power is converted into heat, the voltage of the combined power may be reduced. The clipper circuit is described in detail below with reference to FIG. 11.

According to an embodiment, when the voltage of the combined power is greater than or equal to the first threshold voltage, the combined power may be clipped, and the clipped combined power may be applied to the switch of the BEMF regulating circuit as the target power.

FIG. 11 is a diagram illustrating a configuration of a clipper circuit for clipping combined power appearing in a driving module, according to an embodiment.

According to an embodiment, the clipper circuit 570 described above with reference to FIG. 5D may include a switch 572 and a resistor 574. A connection between the driving module 530 and the resistor 574 may be controlled by the switch 572. The clipper circuit 570 described above may further include a circuit (e.g., a comparator) configured to compare a voltage of combined power 1110 appearing in the driving module 530 with a first threshold voltage. The first threshold voltage may be a reference voltage. The switch 572 may be controlled based on an output of the comparator.

When the driving module 530 and the resistor 572 are connected to each other through the switch 572, at least a portion 1112 of the combined power 1110 appearing in the driving module 530 may be consumed by the resistor 572. The portion 1112 of the combined power 1110 may be dissipated as heat.

The power appearing in the driving module 530 after the portion 1112 of the combined power 1110 is consumed may be referred to as target power 1114. The target power 1114 may be supplied to the switch 910 of the BEMF regulating circuit 580.

FIG. 12 is a flowchart of a method of determining whether a switch connection condition is satisfied, according to an embodiment.

According to an embodiment, the operation 810 described above with reference to FIG. 8 may include the following operations 1210 and 1220.

Operations 1210 and 1220 may be performed by a wearable device (e.g., the wearable device 100 described above with reference to FIGS. 1 to 7). For example, the wearable device may include at least one processor and memory storing instructions.

For example, the at least one processor may include at least one of the processor 512 of FIG. 5A, the processor 535 of FIG. 5C, the processor of the charging circuit 517 or the processor of the battery 518 of FIG. 5D.

The memory of the wearable device 100 may be configured collectively or configured in a distributed manner. Instructions stored in the memory may be stored collectively or configured in a distributed manner. The instructions may be executed by the at least one processor individually or collectively, and functions of the wearable device may be performed by the execution of the instructions.

In operation 1210, the wearable device may receive control information for a switch (e.g., the switch 910 of FIG. 9) of a BEMF regulating circuit (e.g., the BEMF regulating circuit 580 of FIG. 5D and FIG. 9) from an external electronic device (e.g., the electronic device 210 of FIG. 2) through a communication module (e.g., the communication module 516 of FIG. 5A).

According to an embodiment, the wearable device may be connected to an external electronic device directly or indirectly through a communication module. For example, the wearable device may be connected to an external electronic device via cellular communication or short-range wireless communication. An application configured to control the wearable device may be installed on the external electronic device. The user may control a power source or an operation mode of the wearable device through the external electronic device.

The user may activate or deactivate a mode for charging a battery (e.g., the battery 518 of FIG. 5D) of the wearable device using BEMF of a motor (e.g., the motor 534 of FIG. 5D) of the wearable device. For example, in response to a user input, the external electronic device may transmit control information including a command to activate or deactivate the aforementioned mode to the wearable device through an application. The wearable device may receive the control information from the external electronic device. For example, when the control information is a command to activate the mode, “1” may be input to an AND gate of a switch control circuit (e.g., the switch control circuit 920 of FIG. 9) of the BEMF regulating circuit (e.g., the BEMF regulating circuit 580 of FIG. 5D). For example, when the control information is a command to deactivate the mode, “0” may be input to the AND gate of the switch control circuit of the BEMF regulating circuit.

In operation 1220, the wearable device may determine whether the switch connection condition is satisfied based on the control information for the switch of the BEMF regulating circuit.

When there are a plurality of switch connection conditions, it may be determined that the switch connection conditions are satisfied when all of the plurality of switch connection conditions are satisfied. For example, results of the plurality of switch connection conditions may be input to the AND gate of the switch control circuit. When all inputs of the AND gate are “1”, an output of the AND gate may be “1”. When the output of the AND gate is “1”, it may be determined that the switch connection condition is satisfied. When an input of the AND gate is “0”, an output of the AND gate may be “0”. When the output of the AND gate is “0”, it may be determined that the switch connection condition is not satisfied.

Even when all other switch connection conditions are satisfied, when “0” is input to the AND gate of the switch control circuit of the BEMF regulating circuit, the output of the AND gate may be “0”. When the output of the AND gate is “0”, the switch (e.g., the switch 910 of FIG. 9) may be opened so that a driving module (e.g., the driving module 530 of FIG. 5D and FIG. 9) and the BEMF regulating circuit may not be connected to each other.

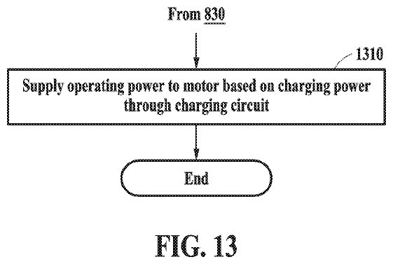

FIG. 13 is a flowchart of a method of supplying operating power to a motor based on charging power through a charging circuit, according to an embodiment.

According to an embodiment, operation 1310 below may be performed after operation 830 described above with reference to FIG. 8 is performed.

Operation 1310 may be performed by a wearable device (e.g., the wearable device 100 described above with reference to FIGS. 1 to 7). For example, the wearable device may include at least one processor and memory storing instructions.

For example, the at least one processor may include at least one of the processor 512 of FIG. 5A, the processor 535 of FIG. 5C, the processor of the charging circuit 517 or the processor of the battery 518 of FIG. 5D.

The memory of the wearable device 100 may be configured collectively or configured in a distributed manner. Instructions stored in the memory may be stored collectively or configured in a distributed manner. The instructions may be executed by the at least one processor individually or collectively, and functions of the wearable device may be performed by the execution of the instructions.

In operation 1310, the wearable device may supply operating power to a motor (e.g., the motor 534 of FIG. 5D) of the driving module (e.g., the driving module 530 of FIG. 5D) based on the charging power through a charging circuit (e.g., the charging circuit 517 of FIG. 5D).

According to an embodiment, when a current state of the wearable device is a state in which the wearable device should supply operating power to the driving module, the wearable device may preferentially supply operating power to the driving module based on the charging power. When the charging power is greater than or equal to the operating power, the wearable device may charge the battery based on the remaining power.

According to an embodiment, the wearable device 100 may include the base body 80 disposed on, directly or indirectly, an area of a lower back of the user 110 when the wearable device 100 is worn on a body of the user 110, the waist support frame 20 and the leg support frame 50 or 55 configured to support at least a part of the body of the user 110, the thigh-fastening portion 1 or 2 configured to fix, directly or indirectly, the leg support frame 50 or 55 to a thigh of the user 110, the IMU 135 disposed within the base body 80, the driving module 35, 45, 120 or 530 configured to generate torque to be applied to a leg of the user 110—wherein the driving module 35, 45, 120 or 530 is disposed between the waist support frame 20 and the leg support frame 50 or 55 and may include the motor 534 and the motor driver circuit 532—, the BEMF regulating circuit 580 configured to generate charging power by regulating target power appearing in the driving module 35, 45, 120 or 530, the charging circuit 517 including the battery 518, the at least one processor 512, 535 or 902, and the memory 514 or 536 storing instructions, wherein the instructions, when executed by the at least one processor 512, 535 or 902 individually or collectively, may cause the wearable device 100 to at least determine whether a switch connection condition is satisfied, based on a target voltage of the target power appearing in the driving module 35, 45, 120 or 530 and a current voltage of the battery 518, in response to the switch connection condition being satisfied, electrically connect the driving module 35, 45, 120 or 530 to the BEMF regulating circuit 580 using the switch 910 of the BEMF regulating circuit 580, generate charging power based on the target power through the regulator 930 of the BEMF regulating circuit 580, and charge the battery 518 based on the charging power through the charging circuit 517.

According to an embodiment, the wearable device 100 may further include the clipper circuit 570 configured to generate the target power based on combined power appearing in the driving module 35, 45, 120 or 530.

According to an embodiment, the instructions, when executed by the at least one processor 512, 535 or 902 individually or collectively, may cause the wearable device 100 to at least determine whether to clip the combined power based on a voltage of the combined power and a predetermined first threshold voltage, and in response to determining to clip the combined power, control the switch 572 of the clipper circuit 570 so that the target power is output by consuming at least a portion of the combined power using the resistor 574 of the clipper circuit 570.

According to an embodiment, the instructions, when executed by the at least one processor 512, 535 or 902 individually or collectively, may cause the wearable device 100 to at least, in response to the target voltage of the target power being within a first range and the current voltage of the battery 518 being within a second range, determine that the switch connection condition is satisfied.

According to an embodiment, the instructions, when executed by the at least one processor 512, 535 or 902 individually or collectively, may cause the wearable device 100 to at least determine whether the switch connection condition is satisfied based on a current state of the wearable device 100.

According to an embodiment, the current state of the wearable device 100 may include at least one of a temperature state, a humidity state, an immersion state, or a vibration state of the wearable device 100 or the battery 518, or an operation mode of the wearable device 100.

According to an embodiment, the wearable device 100 may further include the communication module 516.

According to an embodiment, the instructions, when executed by the at least one processor 512, 535 or 902 individually or collectively, may cause the wearable device 100 to at least receive control information for the switch 910 of the BEMF regulating circuit 580 from an external electronic device through the communication module 516, and determine whether the switch connection condition is satisfied based on the control information for the switch 910 of the BEMF regulating circuit 580.

According to an embodiment, the battery 518 and the driving module 35, 45, 120 or 530 may be electrically connected to each other through at least the diode 519, and current may flow from the battery 518 through the diode 519 to control the motor 534 of the driving module 35, 45, 120 or 530.

According to an embodiment, the instructions, when executed by the at least one processor 512, 535 or 902 individually or collectively, may cause the wearable device 100 to at least supply operating power to the motor 534 based on the charging power through the charging circuit 517.

According to an embodiment, in a battery charging method performed by the wearable device 100, the wearable device 100 may include the base body 80 disposed on an area of a lower back of the user 110 when the wearable device 100 is worn on a body of the user 110, the waist support frame 20 and the leg support frame 50 or 55 configured to support at least a part of the body of the user 110, the thigh-fastening portion 1 or 2 configured to fix the leg support frame 50 or 55 to a thigh of the user 110, the IMU 135 disposed within the base body 80, the driving module 35, 45, 120 or 530 configured to generate torque to be applied to a leg of the user 110 wherein the driving module 35, 45, 120 or 530 is disposed between the waist support frame 20 and the leg support frame 50 or 55 and may include the motor 534 and the motor driver circuit 532-, the BEMF regulating circuit 580 configured to generate charging power by regulating target power appearing in the driving module 35, 45, 120 or 530, the charging circuit 517 including the battery 518, the at least one processor 512, 535 or 902, and the memory 514 or 536 storing instructions, and the battery charging method may include the operation 810 of determining whether a switch connection condition is satisfied based on a target voltage of target power appearing in the driving module 35, 45, 120 or 530 and a current voltage of the battery 518, in response to the switch connection condition being satisfied, the operation 820 of electrically connecting the driving module 35, 45, 120 or 530 to the BEMF regulating circuit 580 using the switch 910 of the BEMF regulating circuit 580, the operation 830 of generating charging power based on the target power through a regulator of the BEMF regulating circuit 580, and the operation 840 of charging the battery 518 based on the charging power through the charging circuit 517.

According to an embodiment, an electronic device may include the driving module 35, 45, 120 or 530 including the motor 534 and the motor driver circuit 532, the BEMF regulating circuit 580 configured to generate charging power by regulating target power appearing in the driving module 35, 45, 120 or 530, the charging circuit 517 including the battery 518, the at least one processor 512, 535 or 902, and the memory 514 or 536 storing instructions, wherein the instructions, when executed by the at least one processor 512, 535 or 902 individually or collectively, may cause the electronic device to at least determine whether a switch connection condition is satisfied, based on a target voltage of the target power appearing in the driving module 35, 45, 120 or 530 and a current voltage of the battery 518, in response to the switch connection condition being satisfied, electrically connect the driving module 35, 45, 120 or 530 to the BEMF regulating circuit 580 using the switch 910 of the BEMF regulating circuit 580 configured to generate charging power by regulating the target power, generate charging power based on the target power through the regulator 930 of the BEMF regulating circuit 580, and charge the battery 518 based on the charging power through the charging circuit 517.

According to an embodiment, the electronic device may further include the clipper circuit 570 configured to generate the target power based on combined power appearing in the driving module 35, 45, 120 or 530.

According to an embodiment, the instructions, when executed by the at least one processor 512, 535 or 902 individually or collectively, may cause the electronic device to at least determine whether to clip the combined power based on a voltage of the combined power and a predetermined first threshold voltage, and in response to determining to clip the combined power, control the switch 572 of the clipper circuit 570 so that the target power is output by consuming at least a portion of the combined power using the resistor 574 of the clipper circuit 570.

According to an embodiment, the instructions, when executed by the at least one processor 512, 535 or 902 individually or collectively, may cause the electronic device to at least, in response to the target voltage of the target power being within a first range and the current voltage of the battery 518 being within a second range, determine that the switch connection condition is satisfied.

According to an embodiment, the instructions, when executed by the at least one processor 512, 535 or 902 individually or collectively, may cause the electronic device to at least determine whether the switch connection condition is satisfied based on a current state of the electronic device.

According to an embodiment, the current state of the electronic device may include at least one of a temperature state, a humidity state, an immersion state, or a measured vibration state of the battery 518, or an operation mode of the electronic device.

According to an embodiment, the electronic device may further include the communication module 516.

According to an embodiment, the instructions, when executed by the at least one processor 512, 535 or 902 individually or collectively, may cause the electronic device to at least receive control information for the switch from an external electronic device through the communication module 516, and determine whether the switch connection condition is satisfied based on the control information for the switch.

According to an embodiment, the battery 518 and the driving module 35, 45, 120 or 530 may be electrically connected to each other through the diode 519, and current may flow from the battery 518 through the diode 519 to control the motor 534 of the driving module 35, 45, 120 or 530.

According to an embodiment, the instructions, when executed by the at least one processor 512, 535 or 902 individually or collectively, may cause the electronic device to at least supply operating power to the motor 534 based on the charging power through the charging circuit 517. “Based on” as used herein covers based at least on.

The embodiments described herein may be implemented using a hardware component, a software component and/or a combination thereof. A processing device may be implemented using one or more general-purpose or special-purpose computers, such as, for example, a processor, a controller and an arithmetic logic unit (ALU), a digital signal processor (DSP), a microcomputer, a field-programmable gate array (FPGA), a programmable logic unit (PLU), a microprocessor or any other device capable of responding to and executing instructions in a defined manner. The processing device may run an operating system (OS) and one or more software applications that run on the OS. The processing device also may access, store, manipulate, process, and generate data in response to execution of the software. For purpose of simplicity, the description of a processing device is used as singular; however, one skilled in the art will appreciate that a processing device may include multiple processing elements and multiple types of processing elements. For example, a processing device may include multiple processors or a processor and a controller. In addition, different processing configurations are possible, such as parallel processors.

The software may include a computer program, a piece of code, an instruction, or some combination thereof, to independently or collectively instruct or configure the processing device to operate as desired. Software and/or data may be embodied permanently or temporarily in any type of machine, component, physical or virtual equipment, computer storage medium or device, or in a propagated signal wave capable of providing instructions or data to or being interpreted by the processing device. The software also may be distributed over network coupled computer systems so that the software is stored and executed in a distributed fashion. The software and data may be stored by one or more non-transitory computer readable recording mediums.

The method according to the embodiments described herein may be recorded in non-transitory computer-readable media including program instructions to implement various operations of the embodiments. The media may also include, alone or in combination with the program instructions, data files, data structures, and the like. The program instructions recorded on the media may be those specially designed and constructed for the purposes of embodiments, or they may be of the kind well-known and available to those having skill in the computer software arts. Examples of non-transitory computer-readable media include magnetic media such as hard disks, floppy disks, and magnetic tape; optical media such as CD ROM discs and DVDs; magneto-optical media such as optical discs; and hardware devices that are specially configured to store and perform program instructions, such as read-only memory (ROM), RAM, flash memory, and the like. Examples of program instructions include both machine code, such as code produced by a compiler, and files including higher level code that may be executed by the computer using an interpreter.

The hardware devices described above may be configured to act as one or more software modules in order to perform the operations of the embodiments described above, or vice versa.

As described above, although the embodiments have been described with reference to the limited drawings, one of ordinary skill in the art may apply various technical modifications and variations based thereon. Suitable results may be achieved if the described techniques are performed in a different order, and/or if components in a described system, architecture, device, or circuit are combined in a different manner and/or replaced or supplemented by other components or their equivalents.

Therefore, other implementations, other embodiments, and equivalents to the claims are also within the scope of the following claims.

1. A wearable device comprising:
a base body configured to be disposed on an area of a lower back of a user when the wearable device is worn on a body of the user;
a waist support frame and a leg support frame configured to support at least a part of the body of the user;
a thigh-fastening portion configured to fix the leg support frame to a thigh of the user;
an inertial measurement unit (IMU), comprising a sensor, disposed at least partially within the base body;
a driving module configured to generate torque to be applied to a leg of the user, wherein the driving module is disposed between at least the waist support frame and the leg support frame and comprises a motor and/or a motor driver circuit;
a back-Electro Motive Force (BEMF) regulating circuit configured to generate charging power by regulating target power appearing in the driving module;
a charging circuit comprising a battery;
at least one processor comprising processing circuitry; and
memory storing instructions,
wherein the instructions, when executed by the at least one processor individually and/or collectively, cause the wearable device to at least:
determine whether a switch connection condition is satisfied, based on a target voltage of the target power appearing in the driving module and a current voltage of the battery,
in response to the switch connection condition being satisfied, electrically connect the driving module to the BEMF regulating circuit via a switch of the BEMF regulating circuit,
generate charging power based on the target power through a regulator of the BEMF regulating circuit, and
charge the battery based on the charging power through the charging circuit.

2. The wearable device of claim 1, further comprising:
a clipper circuit configured to generate the target power based on combined power appearing in the driving module.

3. The wearable device of claim 1, wherein
the instructions, when executed by the at least one processor individually and/or collectively, cause the wearable device to at least:
determine whether to clip the combined power based on a voltage of the combined power and a predetermined first threshold voltage, and
in response to determining to clip the combined power, control a switch of the clipper circuit so that the target power is output by consuming at least a portion of the combined power using a resistor of the clipper circuit.

4. The wearable device of claim 1, wherein
the instructions, when executed by the at least one processor individually and/or collectively, cause the wearable device to at least:
in response to the target voltage of the target power being within a first range and the current voltage of the battery being within a second range, determine that the switch connection condition is satisfied.

5. The wearable device of claim 1, wherein
the instructions, when executed by the at least one processor individually and/or collectively, cause the wearable device to at least:
determine whether the switch connection condition is satisfied based on a current state of the wearable device.

6. The wearable device of claim 1, wherein
the current state of the wearable device comprises at least one of a temperature state, a humidity state, an immersion state, or a vibration state of the wearable device or the battery, or an operation mode of the wearable device.

7. The wearable device of claim 1, further comprising:
a communication module comprising communication circuitry, wherein the instructions, when executed by the at least one processor individually and/or collectively, cause the wearable device to at least:
receive control information for the switch of the BEMF regulating circuit from an external electronic device via at least the communication module, and
determine whether the switch connection condition is satisfied based on the control information for the switch of the BEMF regulating circuit.

8. The wearable device of claim 1, wherein
the battery and the driving module are electrically connected to each other through at least a diode, and
the diode is configured so that current flows from the battery through the diode to control the motor of the driving module.

9. The wearable device of claim 1, wherein
the instructions, when executed by the at least one processor individually and/or collectively, cause the wearable device to at least:
supply operating power to the motor based on the charging power through at least the charging circuit.

10. A battery charging method, performed by a wearable device, the wearable device comprising:
a base body disposed on an area of a lower back of a user when the wearable device is worn on a body of the user;
a waist support frame and a leg support frame configured to support at least a part of the body of the user;
a thigh-fastening portion configured to fix the leg support frame to a thigh of the user;
an inertial measurement unit (IMU), comprising a sensor, disposed at least partially within the base body;
a driving module configured to generate torque to be applied to a leg of the user, wherein the driving module is disposed between at least the waist support frame and the leg support frame and comprises a motor and/or a motor driver circuit;
a back-Electro Motive Force (BEMF) regulating circuit configured to generate charging power by regulating target power appearing in the driving module;
a charging circuit comprising a battery;
at least one processor comprising processing circuitry; and
memory storing instructions,
the battery charging method comprising:
determining whether a switch connection condition is satisfied based on a target voltage of target power appearing in the driving module and a current voltage of the battery;
in response to the switch connection condition being satisfied, electrically connecting the driving module to the BEMF regulating circuit via at least a switch of the BEMF regulating circuit;
generating charging power based on the target power via a regulator of the BEMF regulating circuit; and
charging the battery based on the charging power through the charging circuit.

11. A non-transitory computer-readable storage medium storing a program to perform the method of claim 10.

12. An electronic device comprising:
a driving module comprising a motor and/or a motor driver;
a back-Electro Motive Force (BEMF) regulating circuit configured to generate charging power at least by regulating target power appearing in the driving module;
a charging circuit comprising a battery;
at least one processor comprising processing circuitry; and
memory storing instructions, wherein the instructions, when executed by the at least one processor individually and/or collectively, cause the electronic device to at least:
determine whether a switch connection condition is satisfied, based on a target voltage of the target power appearing in the driving module and a current voltage of the battery,
in response to the switch connection condition being satisfied, electrically connect the driving module to the BEMF regulating circuit via at least a switch of the BEMF regulating circuit configured to generate charging power at least by regulating the target power,
generate charging power based on the target power via a regulator of the BEMF regulating circuit, and
charge the battery based on the charging power via at least the charging circuit.

13. The electronic device of claim 12, further comprising:
a clipper circuit configured to generate the target power based on combined power appearing in the driving module.

14. The electronic device of claim 12, wherein
the instructions, when executed by the at least one processor individually and/or collectively, cause the electronic device to at least:
determine whether to clip the combined power based on a voltage of the combined power and a predetermined first threshold voltage, and
in response to determining to clip the combined power, control the switch of the clipper circuit so that the target power is output by consuming at least a portion of the combined power using the resistor of the clipper circuit.

15. The electronic device of claim 12, wherein
the instructions, when executed by the at least one processor individually and/or collectively, cause the electronic device to at least:
in response to the target voltage of the target power being within a first range and the current voltage of the battery being within a second range,
determine that the switch connection condition is satisfied.

16. The electronic device of claim 12, wherein
the instructions, when executed by the at least one processor individually and/or collectively, cause the electronic device to at least:
determine whether the switch connection condition is satisfied based on a current state of the electronic device.

17. The electronic device of claim 12, wherein
the current state of the electronic device comprises at least one of a temperature state, a humidity state, an immersion state, a measured vibration state of the battery, or an operation mode of the electronic device.

18. The electronic device of claim 12, further comprising:
the communication module comprising communication circuitry,
wherein the instructions, when executed by the at least one processor individually and/or collectively, cause the electronic device to at least:
receive control information for the switch from an external electronic device through the communication module, and
determine whether the switch connection condition is satisfied based on the control information for the switch.

19. The electronic device of claim 12, wherein
the battery and the driving module are electrically connected to each other through at least a diode, and
the diode is configured so that current flows from the battery through the diode to control the motor of the driving module.

20. The electronic device of claim 12, wherein
the instructions, when executed by the at least one processor individually and/or collectively, cause the electronic device to at least:
supply operating power to the motor based on the charging power through the charging circuit.
